(19) United States
(12) Patent Application Publication
(10) Pub. No.: US 2025/0244247 A1
(43) Pub. Date: Jul. 31, 2025

(54) MICROCONTROLLER-BASED AUTOMATIC CHLORIDE TITRATION

(71) Applicant: Saudi Arabian Oil Company, Dhahran (SA)

(72) Inventor: Rami Rajab, Dammam (SA)

(21) Appl. No.: 18/422,560

(22) Filed: Jan. 25, 2024

(51) Int. Cl. G01N 21/78; G01N 21/01; G01N 31/16

(52) U.S. Cl. CPC G01N 21/78; G01N 31/16; G01N 2021/0168

(57) ABSTRACT

Systems and processes for the determination of chloride in water using an automatic chloride titration. The system includes a solenoid valve that controls the flow of titrate from a titrate container, a color sensor, and a microcontroller. During titration of a silver nitrate solution, the color sensor detects the intensity of color in a sample container having a water sample and a color indicator such as potassium chromate. When a specific color intensity appears in the sample container, the microcontroller receives a signal from the color sensor and sends a signal to the solenoid valve to stop the flow of titrate from the titrate container.

### BACKGROUND

### Field of the Disclosure

The present disclosure generally relates to the chemical analysis of water. More specifically, embodiments of the disclosure relate to the determination of chloride content in water using titration.

### Description of the Related Art

Water is an abundant liquid used in many applications and for various purposes. As a solvent, water may be used to dissolve or transport many other substances in aqueous form. For example, water may be used as the solvent for aqueous solutions of numerous ionic compounds. Such ionic compounds may include compounds (for example, salts) of chlorine, such as ionic compounds of chloride (Cl⁻). In particular, chloride compounds may be used in the sterilization of water of various types. However, determining the concentration of chloride ion in water may be difficult and time-consuming.

### SUMMARY

Embodiments of the disclosure generally relate to systems and processes for the determination of chloride in water using a microcontroller-based automatic chloride titration with a color sensor and solenoid valve.

In one embodiment, a system for determining the concentration of chloride ions in water is provided. The system includes a sample container arranged to receive a sample of water and a solenoid valve. The system also includes a titrate container connected to a solenoid valve and arranged to direct a flow of a fluid into the sample container through the solenoid valve, such that the titrate container is arranged to receive a titrate, and a color sensor arranged to detect an intensity of a color in the sample container. The system further includes a microcontroller electrically connected to the solenoid valve and to the color sensor, such that the microcontroller is configured to transmit a first signal to the solenoid valve in response to a second signal from the color sensor.

In some embodiments, the system include the titrate. In some embodiments, the titrate is a silver nitrate solution. In some embodiments, the sample of water includes potassium chromate. In some embodiments, the system includes a relay electrically connected between the microcontroller and the solenoid valve. In some embodiments, the titrate container is a burette. In some embodiments, the first signal includes a signal that causes the solenoid valve to move to a closed position.

In another embodiment, a method for determining the concentration of chloride ions in water is provided. The method includes titrating a titrate into a sample container from a titrate container. The sample container includes a sample of water and potassium chromate, such that the titrate includes a silver nitrate solution. Additionally, the method includes monitoring, using a color sensor, the sample of water during the titration and receiving, at a microcontroller, a signal from the color sensor in response to an intensity of a color of the sample of water. The method also includes receiving, at a solenoid valve, a signal from the microcontroller in response to the signal from the color sensor and moving the solenoid valve to a closed position in response to the signal from the microcontroller.

In some embodiments, receiving, at a solenoid valve, the signal from the microcontroller in response to the signal from the color sensor, includes receiving the signal via a relay electrically connected between the microcontroller and the solenoid valve. In some embodiments, the titrate container is a burette. In some embodiments, the method includes measuring the volume of titrate titrated into the sample container. In some embodiments, the method includes calculating a concentration of chloride in the water sample using the volume of titrate and the concentration of the silver nitrate solution.

In another embodiment, a method of automatic chloride titration is provided. The method includes arranging a sample container on a magnetic stirrer, arranging a titrate container above the sample container, and installing a solenoid valve between the titrate container and sample container such that the solenoid valve controls the flow of titrate. The method also includes installing a color sensor arranged to detect an intensity of color in the sample container and connecting a microcontroller to the color sensor and to the solenoid valve such that the microcontroller is configured to receiver a signal from the color sensor and send a signal to solenoid valve.

In some embodiments, the method includes adding a titrate to the titrate container, such that the titrate includes silver nitrate. In some embodiments, the method includes adding a water sample to the sample container. In some embodiments, the method includes adding a potassium chromate solution to the water sample in the sample container. In some embodiments, the method includes connecting a relay between the microcontroller and the solenoid valve.

### BRIEF DESCRIPTION OF THE DRAWINGS

FIG. 1 is a schematic diagram of a system for automatic chloride titration in accordance with an embodiment of the disclosure; and

FIG. 2 is a flowchart of a process for a microcontroller-based automatic chloride titration system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

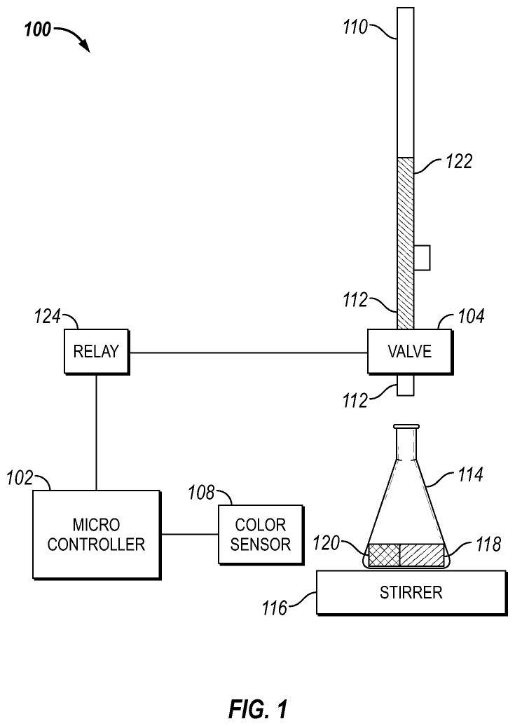

FIG. 1 depicts a system 100 for microcontroller-based automatic chloride titration in accordance with an embodiment of the disclosure. As shown in FIG. 1, the system includes a microcontroller 102, a solenoid valve 104 (for example, a 12 volt (V) solenoid valve), a color sensor 108, a titrate container (for example, a burette 110), tubing 112, a sample container (for example, a flask 114), and a magnetic stirrer 116.

The flask 114 includes a water sample 118 containing the chloride ion for analysis. The flask 114 also includes a potassium chromate indicator 120 added to the water 114. A magnetic stir bar may also be inside the flask 114 for stirring the water sample 118 using the magnetic stirrer 116. In other embodiments, other types of glassware (for example, a beaker) may be used to contain the water sample 118 and receive the titrate. In some embodiments, the potassium chromate indicator 120 may have a concentration of 5% weight/volume (w/v). In other embodiments, other concentrations may be used, such as 2% w/v, 10% w/v, 15 w/v, etc.

The burette 110 is connected to the solenoid valve 104 via tubing 112 (for example, silicon tubing). The burette 110 may contain a titrate, a silver nitrate solution 122, for automatic titration into the flask 114 according to the techniques described in the disclosure. As the solenoid valve 104 is the primary control for flow from the burette 110, any valve on the burette may be moved to the fully open position. In other embodiments, other containers, such as cylinders, tubing (such as tubing connected to another container) may be used for the silver nitrate solution if the amount (for example, volume) of fluid titrated from the titrate container is measurable. In some embodiments, the silver nitrite solution 122 may have a molarity of 0.0141 M and normality of 0.0141 N. In other embodiments, other known molarities or normalities of silver nitrate solution may be used.

The microcontroller 102 is electrically connected to the solenoid valve 104 and the color sensor 108. In some embodiments, the microcontroller 102 is electrically connected to the solenoid valve 104 via a relay 124. In some embodiments, the microcontroller 102 may be an Arduino UNO microcontroller manufactured by Arduino of Lombardia, Italy. In other embodiments, other microcontrollers may be used.

The solenoid valve 104 may be a 12V solenoid valve and may be controlled by the microcontroller 102 to allow or block the flow of silver nitrate solution 122 from the burette 110. As shown in FIG. 1, additional tubing 112 may direct the output of the solenoid valve 104 into the flask 114. When solenoid valve 104 is in the open position, the silver nitrate solution 122 flows via gravity into the flask 114. The solenoid valve 104 closes in response to the appropriate signal from the microcontroller 102. As mentioned supra, in some embodiments the signal from the microcontroller 102 may first be received by the relay 124, which then switches on when receiving the signal and allows the signal to operate the solenoid valve 104.

The color sensor 106 may be oriented to continuously monitor the color of the water sample 118 in the flask 114 as the water sample 118 interacts with the silver nitrate solution 124 flowing from the burette 110. The color sensor 106 may include one more light sources (for example, white light emitting diodes (LEDs)) and multiple photodiodes and filters. For example, the color sensor 106 may include red, green, and blue filters to configure the sensitivity of corresponding photodiodes to red, green, and blue wavelengths of light. The color sensor 106 may be configured to detect an intensity of a specific color of light using specific photodiodes and filters, and may convert the photodiodes' measurements into a signal proportional to the intensity of a specific color. Thus, as the color of the water sample 118 changes to a specific color having a threshold intensity, the color sensor 106 sends a signal to the microcontroller 102 which receives the signal and closes in the solenoid valve 104.

In embodiments using the potassium chromate indicator 120 as the color indicator, the color sensor 108 may be configured to detect the color of silver dichromate produced by the reaction between the silver nitrate solution 122 (the titrate) and the potassium chromate indicator 120. In some embodiments, the color sensor 108 may be a TCS3200 sensor or a TCS230 sensor manufacture by Arduino of Lombardia, Italy.

In some embodiments, the microcontroller 102 may be tangibly or wirelessly connected to a computer (such as desktop, laptop, tablet computer, etc.). in such embodiments, the microcontroller 102 may send data to the computer indicating the end of the titration. For example, the microcontroller 102 may send data such as the color intensity received from the color sensor 108 or other data. In some embodiments, the computer may be provided the volume of silver nitrate solution 122 and may be used to determine the concentration of chloride in the water sample 118. In some embodiments, a flow meter may be installed downstream of the solenoid valve 104 to measure the volume of silver nitrate solution 122 flowing into the flask 114. In some embodiments, the flow meter may be connected to the computer and the flowmeter measurement may be obtained by the computer for use in the determination of chloride concentration. Thus, in such embodiments, the microcontroller-based automatic chloride titration system 100 may be further automated by providing an indicator of the end of the titration and the volume of titrate to a computer for automatic determination of the chloride concentration.

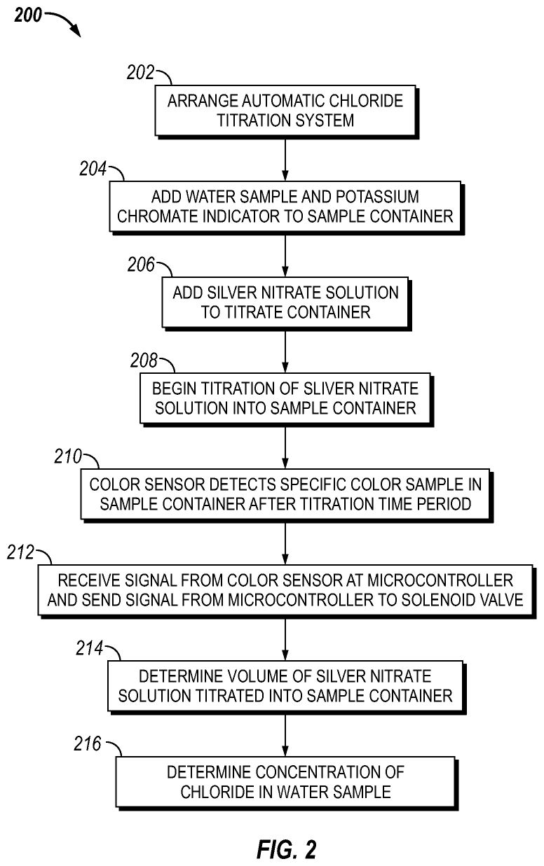

FIG. 2 is a process 200 for determining the concentration of chloride in water using an automatic chloride titration in accordance with an embodiment of the disclosure. Initially, the microcontroller-based automatic chloride titration system is arranged (block 202), such as illustrated in FIG. 1 and describes supra. The solenoid valve and color sensor may be electrically connected to the microcontroller. In some embodiments, the solenoid valve may be electrically connected to the microcontroller via relay. To further arrange the system for titration, the solenoid valve may be set to the open position (that is, 100% open), and the color sensor may be initialized. In embodiments using a relay, the relay may be switched to the off position. Finally, a sample container (for example, a flask) and titrate container (for example, a burette) may be arranged as shown in FIG. 1.

Next, as shown in FIG. 2, a water sample is added to the sample container, and a potassium chromate indicator is added to the water sample (block 204). For example, the water sample may be obtained from a water supply output by a water treatment plant. A silver nitrate solution of known concentration is added to the titrate (block 206).

To begin the titration (block 208), a valve on the titrate container may be open to a desired position sufficient for flow into the sample container with the water sample. During titration, a magnetic stir bar may be placed in the sample container, and a magnetic stirrer may be switched on so that the water sample is stirred during titration. As the titrate (the silver nitrate solution) mixes with the water sample, it interacts with the chloride ions in the sample. As the color of the water sample changes in response to the reaction, the color sensor detects an intensity of the color and sends a signal to the microcontroller (block 210), The microcontroller receives the signal from the color sensor and sends a signal to solenoid valve (for example, via a relay) to move the solenoid valve to a closed position and stop the titration (block 212).

The volume of silver nitrate solution added to the flask is determined (block 214), such as by using measurements on the titrate container. With the known concentration (for example, molarity) and volume of the silver nitrate solution, the moles of chloride in the water sample is calculated using Equation 1:

$$moles {Cl}^{-} = {M}_{{AgNO}_{3}} \times {V}_{{AgNO}_{3}} \qquad ( 1 )$$

Where M_{AgNO}_{₃} is the molarity of the silver nitrate solution in moles/milliliter (ml) and V_{AgNO}_{₃} is the titrated volume of the silver nitrate solution. The concentration of chloride in the water sample may thus be determined (block 216) using the known volume of the water sample. As discussed supra, in some embodiments, a computer may automatically perform the determination of chloride concentration using an indicator of the end of titration and a volume of titrate (such as received from a flowmeter).

The amount of chloride in the water sample may provide an indication of the amount of chlorine in a water supply and, for example, whether water treatment systems are operating correctly. In some embodiments, multiple water samples may be tested using the microcontroller-based automatic chloride titration system to determine the chloride concentration in a water supply. Advantageously, the microcontroller-based automatic chloride titration system described in the disclosure minimizes human intervention regarding the end point of the titration and increases the accuracy of the chloride concentration determination.

### Examples

The following example is included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

An example microcontroller-based automatic chloride titration system according to the techniques of the disclosure was tested using a water solution having a known chloride concentration of 50 parts-per-million. Three titrations were performed, with the results shown in Table 1:

TABLE 1
EXAMPLE TITRATION RESULTS

| Titration No. | Chloride Concentration |
|---|---|
| Run 1 | 56 ppm |
| Run 2 | 57 ppm |
| Run 3 | 53 ppm |

As shown in Table 1, the example microcontroller-based automatic chloride titration system determined a relatively accurate chloride concentration based on the known solution.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A system for determining the concentration of chloride ions in water, comprising:
a sample container arranged to receive a sample of water;
a solenoid valve;
a titrate container connected to a solenoid valve and arranged to direct a flow of a fluid into the sample container through the solenoid valve, wherein the titrate container is arranged to receive a titrate;
a color sensor arranged to detect an intensity of a color in the sample container; and
a microcontroller electrically connected to the solenoid valve and to the color sensor, wherein the microcontroller is configured to transmit a first signal to the solenoid valve in response to a second signal from the color sensor.

2. The system of claim 1, comprising the titrate.

3. The system of claim 2, wherein the titrate is a silver nitrate solution.

4. The system of claim 1, wherein the sample of water comprises potassium chromate.

5. The system of claim 1, comprising a relay electrically connected between the microcontroller and the solenoid valve.

6. The system of claim 1, wherein the titrate container is a burette.

7. The system of claim 1, wherein the first signal comprises a signal that causes the solenoid valve to move to a closed position.

8. A method for determining the concentration of chloride ions in water, comprising:
titrating a titrate into a sample container from a titrate container, the sample container comprising a sample of water and potassium chromate, wherein the titrate comprises a silver nitrate solution;
monitoring, using a color sensor, the sample of water during the titration;
receiving, at a microcontroller, a signal from the color sensor in response to an intensity of a color of the sample of water;
receiving, at a solenoid valve, a signal from the microcontroller in response to the signal from the color sensor; and
moving the solenoid valve to a closed position in response to the signal from the microcontroller.

9. The method of claim 8, wherein receiving, at a solenoid valve, the signal from the microcontroller in response to the signal from the color sensor, comprises receiving the signal via a relay electrically connected between the microcontroller and the solenoid valve.

10. The method of claim 8, wherein the titrate container is a burette.

11. The method of claim 8, comprising measuring the volume of titrate titrated into the sample container.

12. The method of claim 8, comprising calculating a concentration of chloride in the water sample using the volume of titrate and the concentration of the silver nitrate solution.

13. A method of automatic chloride titration, comprising:
arranging a sample container on a magnetic stirrer;
arranging a titrate container above the sample container;
installing a solenoid valve between the titrate container and sample container such that the solenoid valve controls the flow of titrate;
installing a color sensor arranged to detect an intensity of color in the sample container;
connecting a microcontroller to the color sensor and to the solenoid valve, wherein the microcontroller is configured to receiver a signal from the color sensor and send a signal to solenoid valve.

14. The method of claim 13, comprising adding a titrate to the titrate container, wherein the titrate comprises silver nitrate.

15. The method of claim 13, comprising adding a water sample to the sample container.

16. The method of claim 13, comprising adding a potassium chromate solution to the water sample in the sample container.

17. The method of claim 13, comprising connecting a relay between the microcontroller and the solenoid valve.
